(19) United States
(12) Patent Application Publication
(10) Pub. No.: US 2018/0027813 A1
(43) Pub. Date: Feb. 1, 2018

(54) Use of an agent to control resistant rodents

(71) Applicant: BAYER CROPSCIENCE AKTIENGESELLSCHAFT, Monheim am Rhein (DE)

(72) Inventor: Stefan Endepols, Burscheid (DE)

(21) Appl. No.: 15/548,808

(22) PCT Filed: Feb. 9, 2016
(86) PCT No.: PCT/EP2016/052666

§ 371 Date: Aug. 4, 2017

(30) Foreign Application Priority Data
Feb. 10, 2015 (EP) 15154527.4

(51) Int. Cl. A01N 43/16; A01N 25/00; A01N 31/06

(52) U.S. Cl. CPC A01N 43/16; A01N 31/06; A01N 25/004

(57) ABSTRACT

The present invention relates to the use of an agent containing at least one hydroxycoumarin and at least one vitamin D analog for controlling rodents in which there is a practical resistance at least to a second-generation anticoagulant. Furthermore, the present invention also relates to a method for controlling resistant rodents through use of the agents described according to the invention.

The present invention relates to the use of an agent containing at least one hydroxycoumarin and at least one vitamin D analog for controlling rodents in which there is a practical resistance at least to a second-generation anticoagulant. Furthermore, the present invention also relates to a method for controlling resistant rodents through use of the agents described according to the invention.

Anticoagulants, especially hydroxycoumarins, have been used since the 1950s as rodenticidal active ingredients in feed baits and other agents for controlling rodents. Said active ingredients, such as warfarin for example, inhibit the activity of the enzyme vitamin K epoxide reductase, which converts oxidized vitamin K into the active form thereof, vitamin K hydroquinone. A deficiency in the active form of vitamin K causes the insufficient carboxylation of numerous proteins, including factor X in blood coagulation. The conversion of prothrombin into thrombin, a step in the blood coagulation cascade, is thus disrupted, and this can lead to weakening and possibly to the death of an animal after intake of an appropriate dose of coumarin

Anticoagulants for controlling harmful rodents such as brown rats (Rattus norvegicus), black rats (Rattus rattus) and house mice (Mus musculus) have been used since the 1950s. Compared with acute poisons, these active ingredients have the advantage of delayed action, meaning that bait shyness does not occur. Moreover, an effective antidote is available with vitamin K1 in the event of accidental poisoning of, for example, domestic animals.

Just a few years after the market launch of the first anticoagulant rodenticide, warfarin, there were reports of rat tolerance to this active ingredient (e.g., Boyle 1960; Nature 188: 517; Lund 1964, Bull WHO 47: 611-618). Increasing reports of resistance led to the development of second-generation anticoagulant active ingredients in the 1970s to the 1980s, having distinctly higher acute toxicity. But with respect to some of these active ingredients too, increased tolerances or resistances can develop and cross-resistances can occur. In general, resistance to a certain active ingredient includes resistance to all less potent active ingredients as well. If a strain is resistant to a second-generation active ingredient, it is consequently also resistant to all first-generation active ingredients, and also, possibly, less potent second-generation substances. A particular disadvantage of the highly potent second-generation active ingredients is the high toxicity thereof in conjunction with long residue times in the organism, especially the liver. Therefore, these agents are only used in a very restrictive manner. Although rated as persistent and biotoxic and therefore not authorizable in principle, they are still authorized under certain conditions for the time being by the authorities because there is a lack of alternatives.

A major cause of resistance in rats and house mice are sequence change in the gene for vitamin K epoxide reductase complex subunit 1 (VKORC1). Point mutations (Single Nucleotide Polymorphisms, SNPs) in said gene lead to the substitution of certain amino acids of VKORC1. In the case of resistant strains of brown rats, only one amino acid is substituted in each case. Certain sequence changes in VKORC1 result in a change in the properties of the enzyme, which hamper the blocking of the target enzyme by the anticoagulant active ingredients. The consequence are an increased tolerance to anticoagulant active ingredients, as can also occur in humans and hamper the therapeutic use of the relevant medicaments. In the case of rats and mice, the tolerance may be so highly pronounced that relevant anticoagulant control agents do not bring about an adequate control outcome despite correct use. There is then said to be practical resistance when there is good acceptance of bait by the rodents (Greaves, 1994, Buckle A. P. and Smith R. H. eds. “Rodent Pests and their Control”, CABI, Wallingford, Oxon, UK, pages 197-217).

Sequence changes in the VKORC1 gene have different effects, depending on the region of the gene in which they occur. Particularly sequence changes in the region between amino acid positions 120 to 140 of the gene mediate in each case a certain level of resistance in rats and house mice. The substitution of the amino acid tyrosine for cysteine at position 139 of VKORC1 (Tyr139Cys, Y139C) that is widespread in Germany for example makes brown rats and house mice virtually completely insensitive to warfarin, coumatetralyl, bromadiolone, and, in the case of rats, difenacoum too. Individuals having this variant of VKORC1 are capable of maintaining their blood coagulation even at a high dosage of warfarin and other active ingredients.

Particularly in the case of the brown rat, the strains characterized by various SNPs have been very well studied with respect to their sometimes highly differing sensitivity or resistance. For example, in the case of the strain Y139S (known from Wales), while it is known that said strain is somewhat more tolerant to warfarin, there is no practical resistance to the second-generation anticoagulant bromadiolone (Buckle et al. 2007, Int. J. Pest Mgt. 53 (4), 291-297). Resistance is substantially more greatly pronounced in the strain Y139C, the probably most widespread resistant strain (Denmark, Germany, the Netherlands, United Kingdom, France, Belgium). In laboratory and field experiments, it has been demonstrated that said strain is resistant to all first-generation active ingredients, but also to the second-generation active ingredients bromadiolone and difenacoum (see, inter alia, Buckle et al. 2012, Pest. Manag. Sci. 69: 233-239, Endepols et al. 2007, Pest Manag. Sci. 68: 348-354).

A further group of active ingredients that can be used as rodenticide are two forms of vitamin D, ergocalciferol and cholecalciferol (vitamins D2 and D3). These active ingredients show hardly any potential for residue formation and therefore do not represent a risk for predators feeding off rats or mice. An overdose of the vitamin leads to hypercalcemia. Cholecalciferol is therefore used as rodenticide. However, compared to the anticoagulants, the calciferols have so far not been able to gain market acceptance because, in the concentrations used, they cause bait shyness, i.e., an avoidance of the bait, especially in rats or reduce the attractiveness of the bait for rats (Prescott et al. 1992, Proc. 15th Vertebrate Pest Conf., Univ. Calif., Davis, 218-223). After just one day of eating bait containing 0.075% cholecalciferol, rats develop bait shyness, i.e., they no longer feed on the bait, but only on other food sources.

However, it is also known that calciferols can boost the action of certain anticoagulant rodenticides in certain rat strains, i.e., can act synergistically. This effect has been demonstrated in warfarin-resistant rats of the Wales strain Y139S (Kerins et al. 2002, Comp. Clin. Path. 11, 59-64). In the case of nonresistant animals, i.e., animals with normal sensitivity to anticoagulant rodenticides, it is possible to demonstrate at best an additive effect of the two active ingredients (Greaves et al. 1974, J. Hyg. Camb. 73, 341-352).

So far, it has been assumed that this boosting effect only occurs in strains resistant to first-generation anticoagulants, especially warfarin, but not in more strongly resistant strains which are also resistant to second-generation active ingredients such as bromadiolone.

It is therefore an object of the present invention to provide agents which can be used against rodents exhibiting a practical resistance to second-generation anticoagulants. It is a further object to find agents which do not have to rely either on the acutely toxic substances or on the particularly highly potent and residue-forming anticoagulants of the second generation, but are nevertheless effective against anticoagulant-resistant rodents. Furthermore, it is a further object of the present invention to minimize the residue values of anticoagulants in the rodents in order to prevent secondary poisoning of predators as far as possible.

The objects are achieved by the use of an agent for controlling rodents resistant to at least one second-generation anticoagulant, containing at least one hydroxycoumarin and at least one vitamin D analog. Preferably, the agents described according to the invention are used for controlling rodents additionally resistant to at least one first-generation anticoagulant.

Anticoagulants in the context of the invention are substances from the group of the indanedione derivatives or of the hydroxycoumarins, first and second generation. Said substances are used worldwide for controlling rodents (cf. for example DE 2506769; JP 48023942; CH 481580; Paposci (1974): Beihefte Z. Angew. Zool. p. 155 and DE 2506769). Examples of first-generation anticoagulant substances include the 4-hydroxycoumarin derivatives (1-phenyl-2-acetyl)-3-ethyl-4-hydroxycoumarin (“warfarin”), 3-(α-acetonyl-4-chlorobenzyl)-4-hydroxycoumarin (“coumachlor”), 3-(1′,2′,3′,4′-tetrahydro-1′-naphthyl)-4-hydroxycoumarin (“coumatetralyl”), and the indanedione derivatives, such as 1,1-diphenyl-2-acetylindane-1,3-dione (“diphacinone”) and (1′-p-chlorophenyl-1′-phenyl)-2-acetylindane-1,3-dione (“chlorodiphacinone”). The second generation includes: 3-[3-(4′-hydroxy-3′-coumarinyl)-3-phenyl-1-(4′-bromo-4′-biphenyl)propan-1-ol (“bromadiolone”), 3-(3′-paradiphenylyl-1′,2′,3′,4′-tetrahydro-1′-naphthyl)-4-hydroxycoumarin (“difenacoum”), 3-[3-4′-bromobiphenyl-4-yl)-1,2,3,4-tetrahydro-1-naphthyl]-4-hydroxycoumarin (“brodifacoum”), 4-hydroxy-3-[1,2,3,4-tetrahydro-3-[4-(4-trifluoromethylbenzyloxy)phenyl]-1-naphthyl]coumarin (“flocoumafen”) and the hydroxy-4-benzothiopyranones, for example “difethialone”.

In one embodiment of the invention, is based the use of the agents described according to the invention for controlling rodents exhibiting practical resistances to at least one second-generation anticoagulant selected from the group of bromadiolone, difenacoum, flocoumafen, brodifacoum and difethialone (preferably said group but without difethialone). In a more preferred embodiment of the invention, is based the use of the agents described according to the invention for controlling rodents exhibiting practical resistances to at least one second-generation anticoagulant selected from the group of bromadiolone and difenacoum (preferably at least bromadiolone). Even more preferably, the agents described according to the invention are additionally also used for controlling rodents exhibiting practical resistances to first-generation anticoagulants selected from the group of warfarin, coumatetralyl, diphacinone and chlorophacinone (preferably said group but without diphacinone and chlorophacinone). Preferably, there is simultaneously a practical resistance to warfarin, coumatetralyl and bromadiolone. Even more preferably, there is additionally also yet a further practical resistance to difenacoum.

The term “resistance(s)” in the context of the invention refers to “practical resistance”, characterized in that the rodenticide in question no longer achieves sufficient biological efficacy even with proper use and good acceptance of the bait by the rodents (see also Greaves—1994, Buckle A. P. and Smith R. H. eds. “Rodent Pests and their Control”, CABI, Wallingford, Oxon, UK, pages 197-217). A person skilled in the art can make a clear and unambiguous assessment in accordance with this definition as to whether a practical resistance is present or not. In general, the degree of “resistance” can be described by specifying a resistance factor. The resistance factor (RF) is usually calculated on the basis of the lethal dose (LD₅₀) or of the effective dose (ED₅₀). The LD₅₀ is a statistically determined dose which is to be expected to be lethal for 50% of the test animals. The ED₅₀ is a statistically determined dose of an active ingredient, which dose causes a certain response in 50% of the animals; according to the invention, this is a critical value in blood coagulation. LD₅₀ and ED₅₀ are each determined experimentally for each strain. The RF is the quotient formed from the LD₅₀ or ED₅₀ of the resistant strain and of a sensitive strain considered to be the reference. Until the 1980s, RFs were determined on the basis of the LD₅₀. This method was later replaced by blood coagulation tests (BCR resistance tests), by means of which the ED₅₀ can be determined more accurately (Prescott et al. 2007: A standardised BCR-resistance test for all anticoagulant rodenticides. Int. J. Pest Mgt. 53 (4), 265-272). Therefore, it is preferred according to the invention that RF be calculated via the quotient formed from the ED₅₀ of the resistant strain and of a sensitive strain considered to be the reference. According to the invention, ED₅₀ is preferably determined using the BCR resistance test in accordance with the aforementioned literature reference.

A preferred embodiment of the invention is based on the use of the agents described according to the invention for controlling rodents (preferably rats and even more preferably brown rats), wherein there is a practical resistance to bromadiolone and the practical resistance is distinguished by a resistance factor (preferably determined in accordance with the BCR resistance test, see Prescott et al. 2007) of at least 7, preferably at least 10, even more preferably at least 12 and most preferably at least 15, with respect to bromadiolone.

A further preferred embodiment of the invention is based on the use of the agents described according to the invention for controlling rodents (preferably rats and even more preferably brown rats), wherein there is a practical resistance to difenacoum and the practical resistance is distinguished by a resistance factor (preferably determined in accordance with the BCR resistance test) of at least 2, preferably at least 2.9, even more preferably at least 4.8 and most preferably at least 12, with respect to difenacoum.

More strongly resistant strains are distinguished in particular by a bromadiolone resistance. Table 1 below lists the RFs for bromadiolone in the particular resistant brown rat strains:

TABLE 1
Resistance factors for bromadiolone in the known resistant strains of
brown rat (Rattus norvegicus). RF for Y139S was determined on the basis
of the LD₅₀ (BCR resistance test data are not yet available for Y139S), the
RFs of the other strains were determined using the BCR resistance test
(source: Y139S: Buckle et al. 2007, Int. J. Pest Mgt. 53 (4), 291-297);
other strains: Table 2, page 8, RRAC Guidelines on Anticoagulant
Rodenticide Resistance Management; www.rrac.info),

| | | | | L120Q |
|---|---|---|---|---|
| Strain | Y139S | Y139C | Y139F | Hampshire |
| RF | 2.7-6.9 | 15-17 | 7-9 | 10-14 |
| | (determined | (determined | (determined | (determined |
| | on the basis | using the | using the | using the |
| | of LD₅₀) | BCR | BCR | BCR |
| | | resistance | resistance | resistance |
| | | test | test) | test) |

A further preferred variant of the present invention concerns the use of the agents described according to the invention for controlling brown rats, wherein there is practical resistance at least to bromadiolone and the practical resistance is distinguished:
by a resistance factor of at least 15, preferably at least 17 and even more preferably at least 20, in the case of the strain Y139C,
by a resistance factor of at least 7, preferably at least 9 and even more preferably at least 12, in the case of the strain Y139F,
by a resistance factor of at least 10, preferably at least 14 and even more preferably at least 17, in the case of the strain L120Q Hampshire,
   with respect to bromadiolone.

A further preferred variant of the present invention concerns the use of the agents described according to the invention for controlling brown rats, wherein there is practical resistance at least to difenacoum and the practical resistance is distinguished:
by a resistance factor of at least 1.6, preferably at least 2 and even more preferably at least 2.9, in the case of the strain Y139C,
by a resistance factor of at least 4.8, preferably at least 12 and even more preferably at least 15, in the case of the strain L120Q Hampshire,
   with respect to difenacoum.

It is possible to infer from experience and field experiments with various anticoagulants that a 100-percent control with one anticoagulant by itself is no longer possible when the RF exceeds the range of from 3 to 6. Depending on the strain and on the anticoagulant used, difficulties may already occur from the range of from 1.5 to 3 for the RF.

The agents according to the invention are suitable for controlling all resistant harmful rodent strains, including representatives of the genera Microtus, Arvicola, Rattus and Mus. Particularly noteworthy in human settlement areas are the house mouse (Mus musculus/domesticus), the brown rat (Rattus norvegicus) and also the black rat (R. rattus). Preferably, the agents described according to the invention are used against resistant rats such as the brown rat (Rattus norvegicus) or the black rat (R. rattus). Particularly preferably, the described agents are used in controlling brown rats (Rattus norvegicus). Application is possible in open land, and also in buildings, including animal stables, storage spaces and production spaces, and also in sewerage.

Table 2 below summarizes current knowledge about the sensitivity of all known resistant brown rat strains. The data are based on analyses of all available data by resistance working groups in the United Kingdom and Germany (see inter alia: http://www.bpca.org.uk/assets/RRAG_Resistance_Guideline.pdf, Esther et al. 2014, Bundesgesundheitsblatt. DOI 10.1007/s00103-013-1930-z). Only the strain Y139S (Wales) exhibits no practical resistance to second-generation anticoagulants; the other strains are practically resistant to these active ingredients to sometimes differing degrees. This means that these strains are more strongly resistant than the strain Y139S.

TABLE 2
The resistant strains of the brown rat (Rattus norvegicus) that are characterized by
VKORC1 polymorphisms, and the practical resistance thereof to first-generation
anticoagulants (warfarin, chlorophacinone, coumatetralyl) and second-generation
anticoagulants (bromadiolone, difenacoum, brodifacoum, flocoumafen, difethialone).
Assessment is based on field experiments and on values from experience.

| | X = Strain exhibits a practical resistance to: | | | | | |
|---|---|---|---|---|---|---|
| | Warfarin, | | | | | |
| VKORC1 | coumatetralyl | | | | | |
| strain | chlorophacinone | Bromadiolone | Difenacoum | Brodifacoum | Flocoumafen | Difethialone |
| L120Q | X | X | X | — | — | — |
| Berkshire | | | | | | |
| L128Q | X | X | — | — | — | — |
| Y139C | X | X | X | — | — | — |
| Y139F | X | X | — | — | — | — |
| Y139S | X | — | — | — | — | — |

The strain Y139C plays an important role. Firstly, it is, in addition to L120Q Berkshire, the most strongly resistant strain. Secondly, it is the most widespread strain—and this distinguishes it from L120Q (Table 3). Therefore, a demonstration of the efficacy of an agent against this strain is considered to be a general demonstration of the efficacy against resistant rats; only the strain L120Q Berkshire would be able to exhibit a comparable degree of resistance.

TABLE 3
Geographical distribution of resistant rat strains

| Strain | |
|---|---|
| (VKORC1 | |
| marker) | Country |
| Y139C | Denmark, the Netherlands, Belgium, Germany, UK |
| Y139F | France, Belgium |
| Y139S | Wales (UK) |
| L120Q | Hampshire (UK), Berkshire (UK) |
| L128Q | Scotland |

The resistant rat strain “Westphalia”, characterized by the VKORC1 polymorphism Y139C, is resistant to the second-generation anticoagulants bromadiolone and difenacoum, and also to the first-generation active ingredients. Feed baits containing one of these active ingredients in the authorized concentration are not effective against animals of this strain. For example, no mortality was observed in laboratory feeding tests with bromadiolone and coumatetralyl.

A further embodiment of the invention concerns the use of an agent described according to the invention for controlling brown rats resistant at least to a second-generation anticoagulant (and preferably also simultaneously at least to a first-generation anticoagulant), wherein the brown rats have a gene sequence changes in the vitamin K epoxide reductase complex 1 subunit 1 (VKORC1). Preferably, the brown rats have a sequence changes within the VKORC1 gene region encoding amino acid positions 120 to 140 of the VKORC1 protein. Even more preferably, the agents described according to the invention are used for controlling resistant brown rats of the strains L120Q Berkshire, L120Q Hampshire, L128Q, Y139C, Y139F. Even more preferable is the use for controlling the strain Y139C.

In a further embodiment of the invention, the agent used according to the invention contains, as at least one hydroxycoumarin, a hydroxycoumarin selected from the group of warfarin, coumachlor, coumatetralyl, bromadiolone, difenacoum, brodifacoum and flocoumafen. Preferably, only one hydroxycoumarin is used. Preferably again, at least (and preferably as hydroxycoumarin on its own) coumatetralyl is used according to the invention.

Vitamin D analogs in the context of the invention are ergocalciferol and cholecalciferol. They are derivatives of a 3β-hydroxy-Δ5,7-17β-substituted steroid. Calciferols are formed from ergosterol by irradiation. Furthermore, other analogs and metabolites of vitamin D are suitable, such as, for example, hydroxycholecalciferol, dihydroxycholecalciferol, hydroxyergocalciferol, dihydroxyergocalciferol. In a preferred embodiment of the invention, the agent used according to the invention contains, as at least one vitamin D analog, ergocalciferol and/or cholecalciferol. Even more preferably, the agent used according to the invention contains, as vitamin D analog, only cholecalciferol.

According to the invention, it has been found that, surprisingly, coumatetralyl baits are especially effective against resistant rats described above when a small amount of cholecalciferol is added. The addition of cholecalciferol in a concentration of 50 mg/kg to the customary concentration of coumatetralyl is enough to bring about high mortality rates in resistant rats. A cholecalciferol concentration of 100 mg/kg is enough to make it possible to achieve mortality rates of up to 100% (see the examples). As expected, coumatetralyl by itself does not cause mortality. Since also cholecalciferol by itself at 100 mg/kg does not cause mortality, the effect can be solely attributed to a boosted effect of coumatetralyl. The hitherto published demonstrations of a boosting effect of cholecalciferol relate only to the only weakly resistant Wales strain Y139S, which is only slightly resistant to the first-generation active ingredients warfarin and coumatetralyl and exhibits no practical resistance to a second-generation anticoagulant (see also Table 2, p. 16, RRAC Guidelines on Anticoagulant Rodenticide Resistance Management; www.rrac.info).

A further embodiment concerns the use of the agents described according to the invention, wherein the at least one hydroxycoumarin is used in a concentration of from 5 mg/kg to 1000 mg/kg, preferably between 20 and 800 mg/kg (first-generation hydroxycoumarins: warfarin, coumachlor, coumatetralyl) or 10 and 100 mg/kg (second-generation hydroxycoumarins: bromadiolone, difenacoum, brodifacoum and flocoumafen) and particularly preferably between 20 and 750 mg/kg (based on the first-generation hydroxycoumarins) or 10 and 50 mg/kg (based on the second-generation hydroxycoumarins) and very particularly preferably between 250 and 800 mg/kg (based on the first-generation hydroxycoumarins) or 20 and 50 mg/kg (based on the second-generation hydroxycoumarins). If multiple hydroxycoumarins are used, the total concentration of the hydroxycoumarins is also situated within the above-described ranges.

A further embodiment concerns the use of the agents described according to the invention, wherein the at least one vitamin D analog is used in a concentration of from 10 to 1000 mg/kg, preferably between 20 and 200 mg/kg, particularly preferably between 25 and 100 mg/kg, very particularly preferably between 50 and 100 mg/kg. If multiple vitamin D analogs are used, the total concentration of the vitamin D analogs is also situated within the above-described ranges.

Standard field experiments were carried out in order to provide evidence of the effect of the addition of small amounts of cholecalciferol to baits containing a first-generation anticoagulant even under practical conditions. In addition to successful experiments with 100 mg/kg cholecalciferol, an experiment using a smaller concentration of just 50 mg/kg in combination with coumatetralyl was also carried out. Even this reduced amount of cholecalciferol was found to be thoroughly effective (see Example 2). Here, an infestation containing approximately 50% resistant rats of the strain Y139C, i.e., bromadiolone-resistant, was virtually completely erased.

The rat strain Y139C exhibits a practical resistance to two anticoagulant rodenticides of the second generation. Except for one variant of the strain L120Q, which is detected only in Berkshire (England), no strain has such a high level of resistance. A boosting effect of small amounts of cholecalciferol has so far only been demonstrated in the strain Y139S, which is distinctly less tolerant and exhibits no practical resistance to second-generation active ingredients. In this strain, it was possible to demonstrate a boosting effect on the blood-coagulation-inhibiting action of an anticoagulant (Kerins et al. 2002, Comp. Clin. Path. 11, 59-64.). However, this effect was insufficiently strong for an adequate effect to be expected in substantially more strongly resistant rats.

With the addition of a small amount of cholecalciferol which is not effective per se to an anticoagulant rodenticide of the first generation, it is possible to produce control agents which act against strongly resistant rat strains and which have the advantages of the anticoagulant active ingredients (delayed action, antidote), but dispense with the use of second-generation anticoagulants. Environmental risks associated with the use of these persistent active ingredients are thus distinctly reduced.

The invention further provides a method for controlling rodents exhibiting a practical resistance at least to a second-generation anticoagulant, characterized in that an agent containing at least one hydroxycoumarin and at least one vitamin D analog is used. Analogously to the described use, all limiting features also apply to the described method for controlling rodents.

The agents used according to the invention are formulated in the form of all types of rodenticidal feed baits. These are well known from the prior art. What can be recommended are those based on cereals, such as rolled oats, wheat, corn, etc. These can be pourable baits composed of one or more grain components, extruded baits such as granules or pellets, wax blocks, soft or pasty mixtures based on vegetable fats and flours, or gels based on oily or aqueous formulations. What can be especially recommended are pasty baits consisting of cereals or flours and vegetable fat. For example, pasty baits in portion packs of from 10 g to 200 g are highly suitable.

Further administration forms are liquid or gelatinized drinks and also so-called contact agents such as powders and foams. These agents are not feed baits, but are applied such that they stick to the fur of the rodents and are only taken up orally during cleaning.

In further experiments (see Example 3) with rats, it was then additionally found that, surprisingly, there is already a complete termination of feeding activity (“stop-feeding effect”) during the third day of the eating of a bait containing a hydroxycoumarin and cholecalciferol in a small concentration (preferably at a concentration of from 50 to 100 mg/kg and even more preferably between 75 and 100 mg/kg). This can be observed in particular when a feed bait containing a homogeneous distribution of hydroxycoumarin and cholecalciferol dissolved in fats (preferably paste baits or wax blocks) is administered. It is evident that the availability of the cholecalciferol in such feed baits in which said cholecalciferol is dissolved in fat and is homogeneously distributed is very good. The substance is taken up in the digestive tract in a rapid and virtually complete manner. In such experiments, what was particularly surprising was the fact that, despite the “stop-feeding” effect, at least 90% of the rats had taken up a lethal dose of the anticoagulant and died of internal bleeding. Contrary to expectations, a shortening of the feeding period due to the “stop-feeding effect” did not lead to a considerably reduced mortality rate.

In experiments with a first-generation anticoagulant (coumatetralyl; see Example 3), generally only about from 50% to 60% of the bait amount is taken up, such as of baits of the same recipe containing the anticoagulant, but without cholecalciferol. In the case of this reduction in the uptake of the bait or of the active ingredient, a person skilled in the art would have expected that the anticoagulant active-ingredient residues to be detected in the liver decrease in the same proportion. However, it was found that, completely surprisingly, said residues are substantially further reduced in experimental groups which received the anticoagulant in combination with cholecalciferol than could be inferred from the proportion of the feeding amounts.

Therefore, in a further embodiment of the invention, the agents described according to the invention are additionally especially also used for decreasing in the rodent (and in particular in the liver of the rodent) the residue values of the hydroxycoumarin(s) used. With such an application of the agents described according to the invention, environmental risks associated with the use of the anticoagulants are considerably reduced. This includes, for example, the risk of secondary poisoning of predators such as birds of prey, owls or weasels which eat rodents which have consumed rodenticidal feed baits. The invention further provides the method described according to the invention, wherein said method is preferably also used for decreasing in the rodent the residue values of the hydroxycoumarin(s) used.

### EXAMPLES

### Example 1

Feeding Experiment with Brown Rats of the Resistant Strain Y139C, Bait Containing Coumatetralyl (375 mg/kg) and Cholecalciferol (100 mg/kg).

6 brown rats of the strain Y139C (2 male and 4 female) received feed baits, as described below, over a period of 4 days. Consumption and mortality were determined afterwards. One group (6 rats, Group 1) was fed a feed bait consisting of coumatetralyl (375 mg/kg) and cholecalciferol (100 mg/kg). The other group (Group 2) was fed coumatetralyl on its own (375 mg/kg). All animals consumed the feed baits except for one animal from Group 2. Consumption was highest during the first 24 hours. On the third and fourth day, there was only little consumption. All 6 rats died after 5 to 7 days in Group 1 after the start of the experiment. Two males each consumed approximately 47 mg/kg coumatetralyl and 12.5 mg/kg cholecalciferol (based on the body weight). The females consumed from 50 to 79 mg/kg coumatetralyl and from 13 to 21 mg/kg cholecalciferol (based in each case on the body weight). In Group 2, no mortality was observed, although the animals consumed 94 mg/kg coumatetralyl (mean value based on the body weight). The combination of coumatetralyl and cholecalciferol was lethal and shows that this combination acts against resistant brown rats of the strain Y139C.

### Example 2

### Field Experiment on a Farm in the Münsterland Resistance Area, Westphalia, Germany.

The main area of distribution of the bromadiolone-resistant strain Y139C is the Münsterland (Germany). Rats of this resistance strain can be found on numerous livestock farms. They are resistant to coumatetralyl and the second-generation anticoagulants bromadiolone and difenacoum (Buckle et al. 2012, Pest Manag Sci 69: 233-239; Endepols et al. 2007, Int. J. Pest Mgt. 53 (4), 285-290, Endepols et al. 2012, Pest Manag. Sci. 68: 348-354). A field experiment was carried out on such a farm using bait containing coumatetralyl (375 mg/kg) and cholecalciferol (50 mg/kg). The frequency and degree of resistance on the farm was determined prior to control with the rodenticidal bait. To this end, rats were caught and tested in a blood coagulation test with coumatetralyl. Result: approximately 46% of the rats on the farm were resistant for coumatetralyl with the resistance factor at from 60 to 80. Thereafter, the bait was applied for 35 days in a standard method. Control success was 94% after eating of 7.3 kg of the bait. In general, a result at this level is judged to be a very good success and to be a demonstration of efficacy, because it must be calculated under practical conditions with immigration of rats from the surrounding land. For the official authorization of a product, 90% control success is judged to be a demonstration of efficacy. Therefore, the result of this field experiment is judged to be a demonstration of the full efficacy of bait containing coumatetralyl and cholecalciferol against the bromadiolone-resistant strain Y139C.

### Example 3: Experimental Evidence of the Stop-Feeding Effect and of Residue Reduction

### Method:

In a laboratory experiment with brown rats (Rattus norvegicus) of a wild strain, the feeding amounts of two baits of identical composition except for the addition of cholecalciferol were compared. Both baits were fat-based paste baits, Bait A containing the anticoagulant coumatetralyl (375 mg/kg), and Bait B containing coumatetralyl (375 mg/kg) and cholecalciferol (100 mg/kg). Both baits were offered ad libitum for 10 days to groups each containing six male and female adult rats. The individual daily feeding amounts were determined, and calculated in relation to the body weight. In all the rats that died during the experiment, the coumatetralyl residues were determined in the liver and in the rest of the body.

### Result:

In Group A (coumatetralyl only), consumption of the bait was 222.1 g/kg. In Group B (coumatetralyl and cholecalciferol), 126.5 g/kg were consumed, i.e., only 57% of the amount eaten in Group A. This difference can be attributed to a “stop-feeding effect” in Group B, which stopped feeding on the third day (Table 4). Mortality was 11/12 in Group A and 12/12 in Group B. The residues of coumatetralyl in the livers of the animals differed more greatly than was to be expected on the basis of the feeding data: in Group B, the residues were only 31% of the values in Group A.

TABLE 4
Bait feeding amounts in g/kg body weight/day in groups each
containing 12 rats, and residues of coumatetralyl in the liver
(average values). Group A: coumatetralyl (375 mg/kg); Group B:
coumatetralyl (375 mg/kg) + cholecalciferol (100 mg/kg).

| | Group A | Group B | Ratio B:A |
|---|---|---|---|
| Bait, day 1 (g/kg) | 50.4 | 53.5 | 1.06 |
| Bait, day 2 (g/kg) | 50.4 | 51.9 | 1.03 |
| Bait, day 3 (g/kg) | 41.5 | 20.7 | 0.50 |
| Bait, day 4 (g/kg) | 35.4 | 0.0 | 0 |
| Bait, day 5 (g/kg) | 15.3 | 0.0 | 0 |
| Bait, day 6 (g/kg) | 9.5 | 0.0 | 0 |
| Bait, day 7 (g/kg) | 6.9 | 0.0 | 0 |
| Bait, day 8 (g/kg) | 6.0 | 0.0 | 0 |
| Bait, day 9 (g/kg) | 5.9 | 0.0 | 0 |
| Bait, day 10 (g/kg) | 0.8 | 0.0 | 0 |
| Coumatetralyl, liver | 11.43 | 3.58 | 0.31 |
| (ug/g) | (n = 11) | (n = 12) | |

1. A product comprising an agent for controlling one or more rodents in which there is a practical resistance to at least one second-generation anticoagulant, wherein the agent contains at least one hydroxycoumarin and at least one vitamin D analog.

2. The product as claimed in claim 1, wherein the second-generation anticoagulant is selected from the group of bromadiolone and difenacoum.

3. The product as claimed in claim 1, wherein there is additionally a practical resistance to at least one first-generation anticoagulant.

4. The product as claimed in claim 3, wherein the first-generation anticoagulants are selected from the group of warfarin, coumatetralyl, diphacinone and chlorophacinone.

5. The product as claimed in claim 1, wherein there is a resistance to bromadiolone and the practical resistance is distinguished by a resistance factor of at least 7 with respect to bromadiolone.

6. The product as claimed in claim 1, wherein there is a practical resistance to difenacoum and the practical resistance is distinguished by a resistance factor of at least 2 with respect to difenacoum.

7. The product as claimed in claim 1, wherein the rodents are rats.

8. The product as claimed in claim 7, wherein the rats are brown rats.

9. The product as claimed in claim 8, wherein the brown rats have a gene sequence changes in the vitamin K epoxide reductase complex 1 subunit 1 (VKORC1).

10. The product as claimed in claim 9, wherein the brown rats are of the strain L120Q Berkshire, L120Q Hampshire, L128Q, Y139C, Y139F.

11. The product as claimed in claim 10, wherein there is a practical resistance at least to bromadiolone and the practical resistance is distinguished
by a resistance factor of at least 15, in the case of strain Y139C,
by a resistance factor of at least 7, in the case of strain Y139F, and
by a resistance factor of at least 10, in the case of strain L120Q Hampshire, with respect to bromadiolone.

12. The product as claimed in claim 1, wherein the at least one hydroxycoumarin is coumatetralyl.

13. The product as claimed in claim 1, wherein the at least one vitamin D analog is selected from the group of ergocalciferol and cholecalciferol.

14. The product as claimed in claim 1, wherein the agent is used for decreasing in the rodent the residue values of the at least one hydroxycoumarin used.

15. A method for controlling one or more rodents for which there is a practical resistance at least to a second-generation anticoagulant, wherein an agent containing at least one hydroxycoumarin and at least one vitamin D analog is used to control said rodents.
